(19) United States
(12) Patent Application Publication
(10) Pub. No.: US 2015/0100294 A1
(43) Pub. Date: Apr. 9, 2015

(54) APPARATUS AND METHOD FOR MODELING AND PREDICTING SEDATIVE EFFECTS OF DRUGS SUCH AS PROPOFOL ON PATIENTS

(71) Applicants: Louis J. Wilson, Wichita Falls, TX (US); Dale B. McDonald, Wichita Falls, TX (US); James N. Johnston, Holliday, TX (US)

(72) Inventors: Louis J. Wilson, Wichita Falls, TX (US); Dale B. McDonald, Wichita Falls, TX (US); James N. Johnston, Holliday, TX (US)

(21) Appl. No.: 14/049,297

(22) Filed: Oct. 9, 2013

(51) Int. Cl. G06F 19/00

(52) U.S. Cl. CPC G06F 19/3437
USPC 703/11

(57) ABSTRACT

A method includes receiving characteristics of a patient to be administered a sedative for a medical procedure. The method also includes selecting one of multiple models based on at least one of the characteristics and a sedation technique to be used. The method further includes calculating an index to the selected model using one or more of the characteristics. In addition, the method includes identifying a specified dosage of the sedative using the selected model and calculated index. The characteristics of the patient could include a height, weight, age, and race of the patient. Selecting one of the models could include selecting one of the models based on the patient's race and the sedation technique. The models could include different models associated with different sedation techniques. Calculating the index could include multiplying the patient's height by the patient's weight and dividing a resulting product by the patient's age.

### TECHNICAL FIELD

This disclosure relates generally to the modeling and prediction of patient reactions. More specifically, this disclosure relates to an apparatus and method for modeling and predicting the sedative effects of drugs, such as propofol, on patients.

### BACKGROUND

Various drugs have been used over the years to induce “conscious sedation” of patients prior to and during medical procedures. For example, patients are routinely sedated to moderate levels in outpatient or ambulatory surgical centers. As a particular example, patients can be sedated to moderate levels prior to endoscopic procedures using a combination of fentanyl (a narcotic drug) and midazolam (a sedative/hypnotic drug). However, both fentanyl and midazolam have highly-individualized effects, meaning the effects of these drugs are highly variable across different patients. This can make it difficult to anticipate a particular patient's reactions to these drugs, making it more difficult to sedate the particular patient for a medical procedure.

### SUMMARY

This disclosure provides an apparatus and method for modeling and predicting the sedative effects of drugs, such as propofol, on patients.

In a first embodiment, a method includes receiving characteristics of a patient to be administered a sedative for a medical procedure. The method also includes selecting one of multiple models based on (i) at least one of the characteristics and (ii) a sedation technique to be used. The method further includes calculating an index to the selected model using one or more of the characteristics. In addition, the method includes identifying a specified dosage of the sedative using (i) the selected model and (ii) the calculated index.

In a second embodiment, an apparatus includes at least one memory configured to store multiple models, where each model is associated with dosages of a sedative for a medical procedure. The apparatus also includes at least one processing device configured to receive characteristics of a patient to be administered the sedative and select one of the models based on (i) at least one of the characteristics and (ii) a sedation technique to be used. The at least one processing device is also configured to calculate an index to the selected model using one or more of the characteristics and identify a specified dosage of the sedative using (i) the selected model and (ii) the calculated index.

In a third embodiment, a non-transitory computer readable medium embodies a computer program. The computer program includes computer readable program code for receiving characteristics of a patient to be administered a sedative for a medical procedure. The computer program also includes computer readable program code for selecting one of multiple models based on (i) at least one of the characteristics and (ii) a sedation technique to be used. The computer program further includes computer readable program code for calculating an index to the selected model using one or more of the characteristics. In addition, the computer program includes computer readable program code for identifying a specified dosage of the sedative using (i) the selected model and (ii) the calculated index.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIGS. 1 and 2 illustrate an example method for using propofol to sedate patients and related details according to this disclosure;

FIGS. 3 and 4 illustrate example effects of different sedation techniques, including those using propofol, according to this disclosure;

FIGS. 5 through 11 illustrate example factors affecting the dosage of propofol during a sedation process according to this disclosure;

FIGS. 12 through 14 illustrate an example generation of models for modeling and predicting the effects of sedatives, such as propofol, on patients according to this disclosure;

FIG. 15 illustrates an example system for modeling and predicting the effects of sedatives, such as propofol, on patients according to this disclosure;

FIG. 16 illustrates an example method for modeling the effects of sedatives, such as propofol, on patients according to this disclosure; and

FIG. 17 illustrates an example method for predicting the effects of sedatives, such as propofol, on patients according to this disclosure.

### DETAILED DESCRIPTION

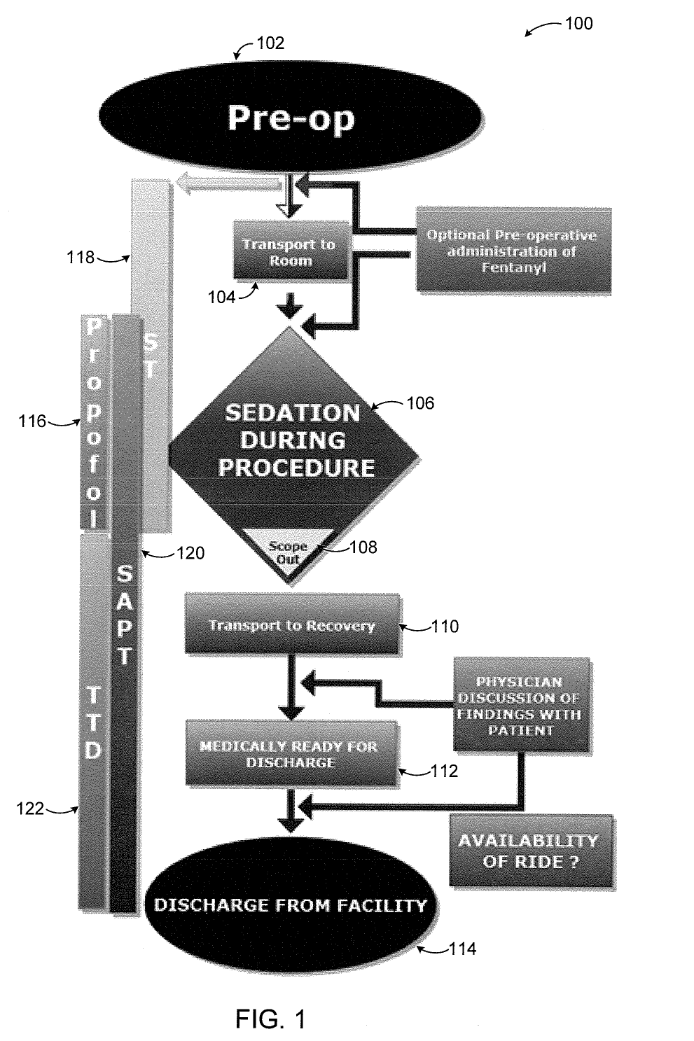

FIGS. 1 through 17, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

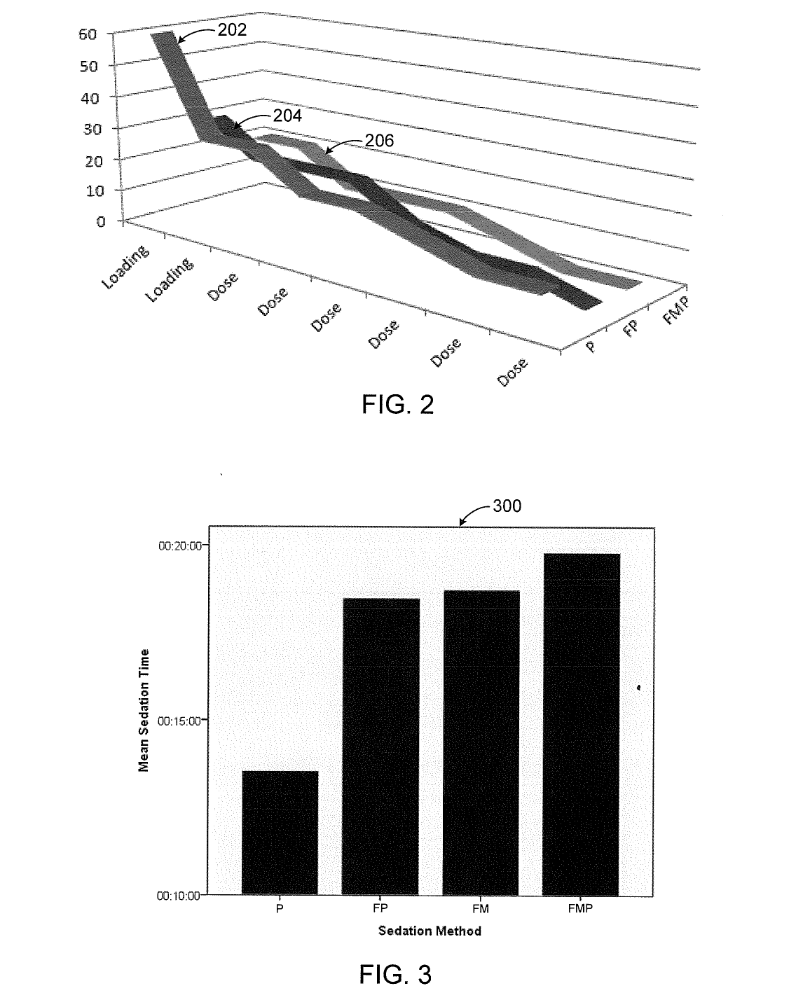

FIGS. 1 and 2 illustrate an example method 100 for using propofol to sedate patients and related details according to this disclosure. In the following description, it may be assumed that sedation is part of an endoscopic medical procedure. However, propofol could be used to sedate patients for any other suitable medical procedure.

As shown in FIG. 1, the method 100 begins with one or more pre-operative (“pre-op”) procedures at step 102. The pre-op procedures generally prepare a patient for surgery or other medical procedure. This could include, for example, a nurse or other medical practitioner verifying that the patient has refrained from eating or drinking or from taking medication for a specified period of time. This could also include the patient changing clothes and a nurse or other medical practitioner administering drugs to the patient. As part of the pre-op procedures, a narcotic drug (such as fentanyl) or other medication can be given to the patient. Once the patient is ready for surgery, the patient can be transported to a procedure room or other location at step 104.

A medical procedure occurs at step 106. As explained below, during the medical procedure, propofol is used to sedate the patient. Propofol is a sedative/hypnotic drug with highly dose-dependent properties. Propofol can be titrated for use in light to moderate sedation up to deep sedation or even surgical levels of general anesthesia. Propofol is very short-acting with an onset of action in about 40 seconds and a peak effect from about one minute to about three minutes. The patient is therefore typically re-dosed with propofol periodically, such as every three to five minutes, to maintain the effect. Propofol could be supplied to the patient in any suitable manner, such as continuously or using repeated boluses. During a final stage 108 of the medical procedure, the need for sedation can end, and the delivery of propofol can stop. In an endoscopic procedure, the final stage 108 could represent the stage in which an endoscope is removed from the patient (although other medical procedures can have different stages in which sedation is no longer used).

Once the medical procedure is completed, the patient is transported to a recovery area at step 110, becomes medically ready for discharge at step 112, and is discharged at step 114. At some point during this process, the patient can discuss the medical procedure and any results with a physician, and medical personnel can verify that the patient has suitable transport.

Note that this represents a simplified example of a medical procedure and that any additional steps can occur during the medical procedure. For example, the patient may undergo several medical procedures prior to discharge. As another example, additional steps may be needed if there are any complications before, during, or after the medical procedure.

Also note that, in some embodiments, the use of propofol could be limited to medical procedures requiring moderate sedation. Moderate sedation is typically characterized by purposeful patient response to tactile stimuli while maintaining ventilation. Moderate sedation is used in many routine procedures, including many outpatient procedures. This is in contrast to deep sedation in which the patient responds only to painful stimuli and may require airway support. However, in other embodiments, the use of propofol is not limited to medical procedures requiring only moderate sedation, and propofol dosages can be modeled and predicted for any suitable level of sedation.

There are various time periods defined in FIG. 1. A “propofol” time period 116 defines the period of time in which propofol is actively administered to a patient. A sedation time (ST) 118 defines the entire period of time in which the patient is sedated as a result of the administration of a sedative or other drug pre-op, during the procedure, or post-op. Depending on the sedation method, the sedation time 118 could begin with pre-op administration of fentanyl or other drug(s) for some methods and administration of drug(s) in the procedure room for other methods. It is assumed here that no sedation is required after the procedure, although the sedation time 118 could extend into the post-op period. A sedation-associated process time (SAPT) 120 defines the period of time from the first administration of any drug to the patient's final discharge. A total time to discharge (TTD) 122 defines the period of time between when the administration of sedative(s) ceases to the patient's final discharge.

FIG. 2 illustrates example dosages of propofol that can be given to a patient during the process of FIG. 1. In FIG. 2, there are three dosage indicators 202-206 identifying example dosages of propofol that could be given to a patient over time. In this example, the dosage indicator 202 identifies example dosages of propofol only (P) given to sedate a patient during a medical procedure. The dosage indicator 204 identifies example dosages of propofol that can be given to a patient who has also received fentanyl (FP) during a medical procedure. The dosage indicator 206 identifies example dosages of propofol that can be given to a patient who has also received fentanyl and midazolam (FMP) during a medical procedure.

As can be seen in FIG. 2, each dosage indicator 202-206 generally indicates that one or more larger doses of propofol are initially administered to a patient. As time goes on, relatively smaller doses of propofol are administered to the patient until sedation (at least using propofol) is no longer required. Also, it can be seen that less propofol is used when the patient is administered fentanyl, and even less propofol is used when the patient is administered fentanyl and midazolam. The administration of fentanyl reduces the propofol dosage in a manner generally independent of the fentanyl dose, and the administration of midazolam reduces the propofol dosage in a manner dependent on the midazolam dose.

Note that the specific dosage values shown in FIG. 2 are for illustration only and can vary. As described in more detail below, the specific dosage(s) of propofol for a particular patient can vary based on the particular patient's characteristics (such as height, weight, age, and race) and can be estimated using one or more models.

The use of propofol as a sedative agent during medical procedures may be preferable over other commonly-used sedatives. For example, the use of propofol as a moderate sedative has a lower mortality rate than other sedative techniques. This is particular true when compared to the mortality rate associated with traditional two-drug sedation (fentanyl and midazolam) by non-anesthesiologists. Moreover, sedation using propofol can provide various benefits to patients and to medical professionals who are treating the patients.

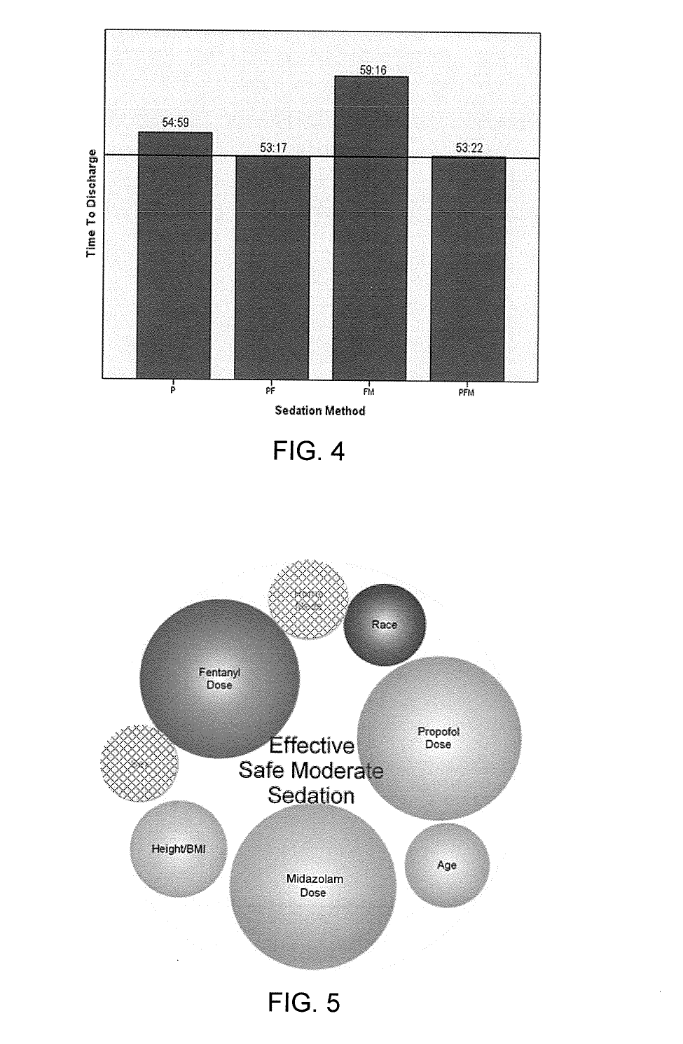

FIGS. 3 and 4 illustrate example effects of different sedation techniques, including those using propofol, according to this disclosure. In particular, FIGS. 3 and 4 illustrate example effects associated with sedations performed using propofol only (P), fentanyl and propofol (FP), fentanyl and midazolam (FM), and fentanyl and midazolam with propofol (FMP) as the sedation techniques.

In FIG. 3, a graph 300 plots the average sedation time for sedations performed using the four different sedation techniques. As can be seen in FIG. 3, sedations using only propofol can require significantly less total sedation time than other sedation techniques. This is because sedations using only propofol may avoid a pre-op administration of fentanyl and involve the administration of propofol only during the medical procedure. The graph 300 therefore does not show a real difference in efficiency in the use of propofol. However, the graph 300 still shows that a patient may be sedated for significantly less time overall when only propofol is used. Moreover, techniques involving the administration of propofol combined with fentanyl and optionally midazolam have similar sedation times compared to the conventional fentanyl-midazolam technique.

In FIG. 4, a graph 400 plots the average time to discharge for sedations performed using the four different sedation techniques. Time to discharge may represent the broadest measure of discharge efficiency and can be measured in a consistent and objective manner regardless of sedation technique. The sedation-associated process time measures the overall effect of sedation on efficiency but varies depending on the sedation technique. Thus, time to discharge can be used for comparing discharge efficiency between sedation techniques. As shown in FIG. 4, sedations using propofol (including those using fentanyl and optionally midazolam) all have improved average times to discharge compared to the conventional fentanyl-midazolam technique.

As a result, sedations using propofol can be safer than the conventional fentanyl-midazolam sedation technique while providing similar or improved sedation times and improved times to discharge. However, many medical professionals may have little or no experience in administering propofol for sedation purposes during medical procedures. Moreover, even medical professionals who have experience administering propofol may have difficulty identifying the proper dosages of propofol for specific patients.

This disclosure provides an apparatus and method that facilitate both modeling and predicting the effects of sedatives, such as propofol, on patients. The apparatus and method generally operate using independent factors found to have a significant effect on propofol dosage. The apparatus and method can be used to predict the propofol dosage for a particular patient, either for a single dosage (such as at the beginning of a medical procedure) or for multiple dosages (such as repeated during a medical procedure). This information can be used by a medical professional to then select the actual propofol dosage used for the particular patient.

FIGS. 5 through 11 illustrate example factors affecting the dosage of propofol during a sedation process according to this disclosure. FIG. 5 illustrates a general overview of the factors affecting propofol dosage. As shown in FIG. 5, it has been discovered that the independent factors affecting propofol dosage include the age and the race of a patient, as well as the height and weight of the patient (one or both of which can be incorporated using a body mass index or “BMI” of the patient). It has also been discovered that a patient's sex does not have a significant effect on propofol dosage, nor does the home use of pain medications, anti-depressants, or anxiolytics. As noted above, it is known that the administration of fentanyl or fentanyl and midazolam affects the dosage of propofol.

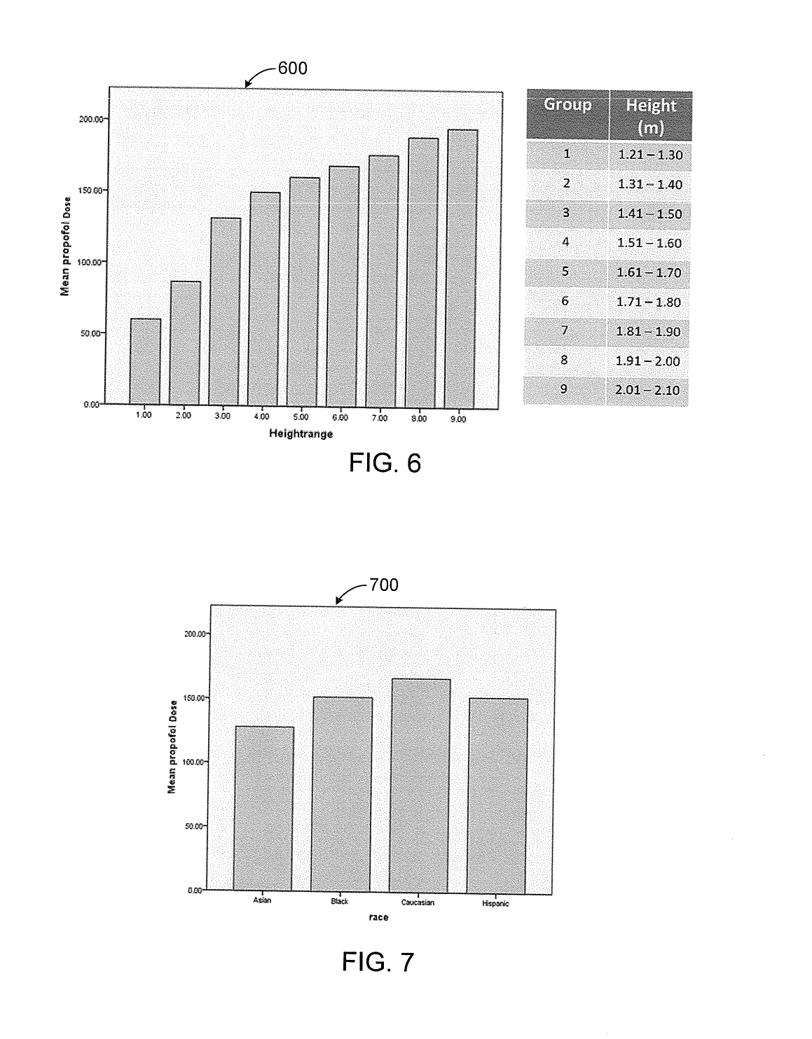

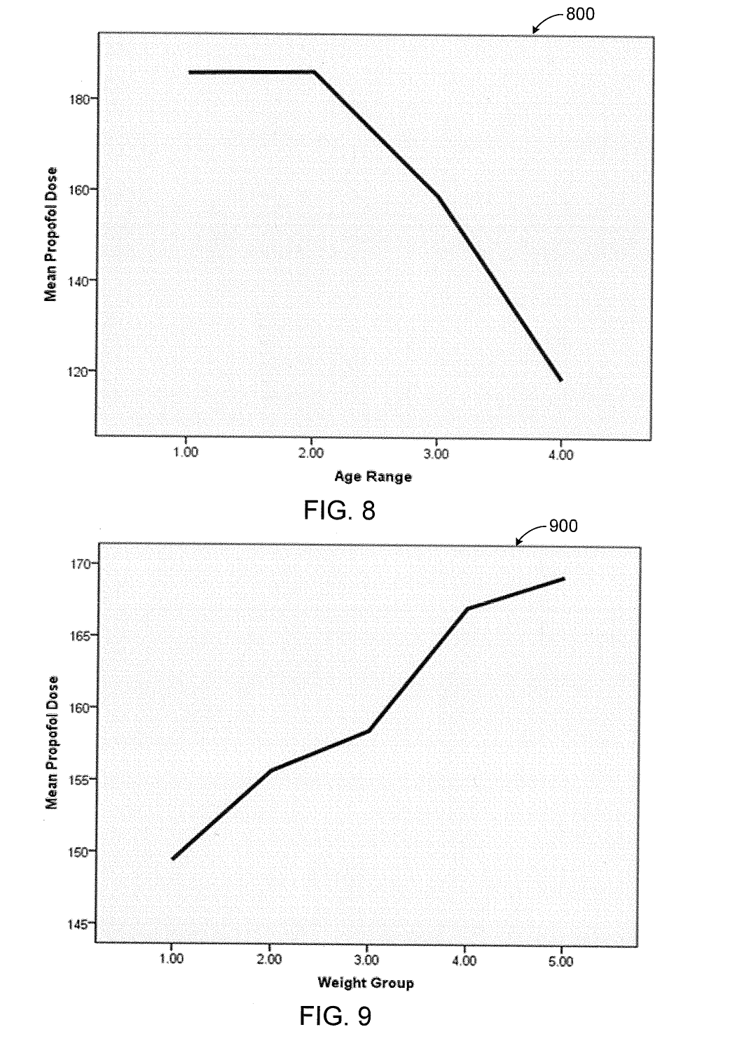

In FIG. 6, a graph 600 plots propofol dosage against patient height. In this example, patient height is divided into bins, and each bin spans a range that is 0.1 meters wide. As can be seen in FIG. 6, increasing patient height is associated with increasing propofol dosages. In FIG. 7, a graph 700 plots propofol dosage against patient race. As can be seen in FIG. 7, propofol dosages can differ between patients of different races. In FIG. 8, a graph 800 plots propofol dosage against patient age. In this example, patient age is divided into bins. As can be seen in FIG. 8, increasing patient age is associated with decreasing propofol dosages (past a certain age). In FIG. 9, a graph 900 plots propofol dosage against patient weight. In this example, patient weight is divided into bins. As can be seen in FIG. 9, increasing patient weight is associated with increasing propofol dosages.

Each of these four factors can independently affect propofol dosage. This means that each factor affects propofol dosage regardless of the other factors. For example, regardless of race, weight, and age, the propofol dosage generally increases based on patient height. Also, different factors can affect propofol dosage for the same patient in different ways, such as when a patient's height is associated with a higher propofol dosage and the patient's weight is associated with a lower propofol dosage.

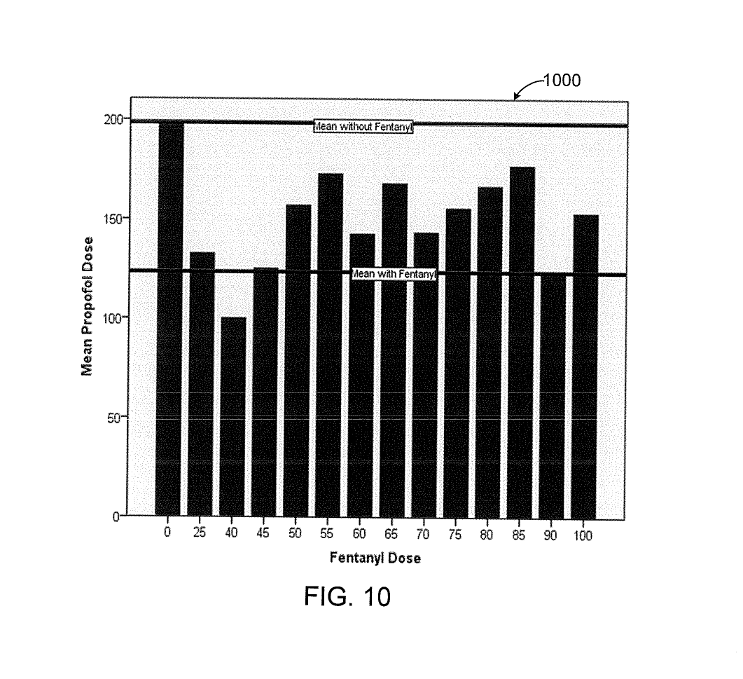

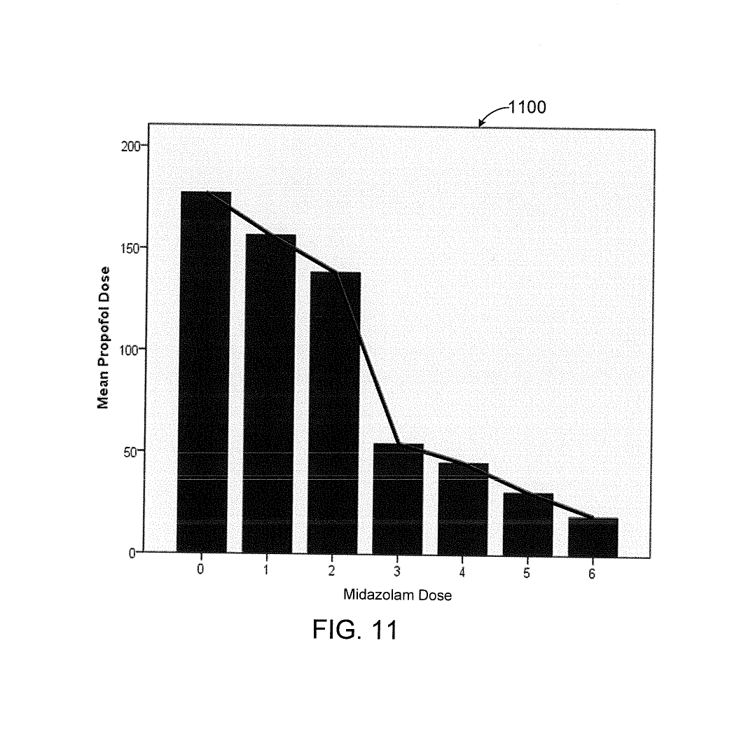

In FIGS. 10 and 11, graphs 1000 and 1100 illustrate the effects of fentanyl dosage and midazolam dosage on propofol dosage. As can be seen here, fentanyl generally lowers the propofol dosage in a manner independent of the fentanyl dosage, while midazolam generally lowers the propofol dosage in a manner dependent of the midazolam dosage.

It is possible to combine these various factors to generate mathematical models representing propofol dosages. For example, in some embodiments, multiple models can be created for different combinations of these factors. As a particular example, models can be created for the propofol only (P) technique, the fentanyl-propofol (FP) technique, and the fentanyl-midazolam-propofol (FMP) technique (possibly with different models associated with different midazolam dosages). Also, these same types of models can be generated for each patient race. Each of these models can then associate a patient's height, weight, and age with an optimal average propofol dosage.

Once these models are created, the models can be used in any suitable manner. For example, a medical professional could select one of the models based on a particular patient's race and a specific sedation technique to be used. The medical professional could then plug the patient's data (such as height, weight, and age) into the selected model in order to obtain a predicted propofol dosage to be used during a medical procedure. At this point, the medical professional can use the predicted propofol dosage as a starting point and make any adjustments deemed necessary or desirable to the predicted dosage.

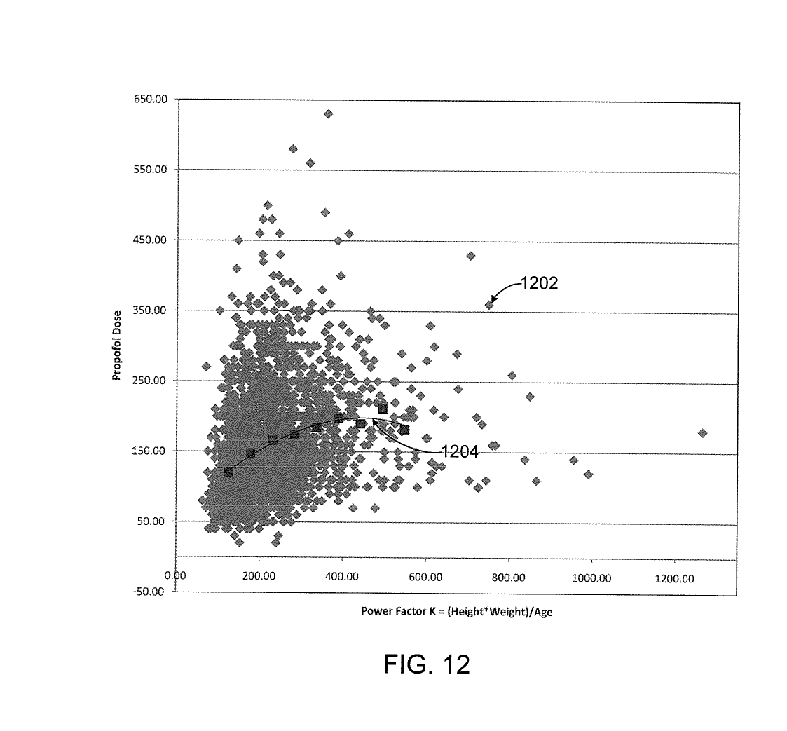

FIGS. 12 through 14 illustrate an example generation of models for modeling and predicting the effects of sedatives, such as propofol, on patients according to this disclosure. In the following example, mathematical models associate a “patient factor” (denoted K) with propofol dosage, where the patient factor K is calculated as:

$$K = \frac{Height * Weight}{Age}$$

As shown here, a particular patient's height, weight, and age are used to calculate the patient-specific factor K. This patient factor K can then be used with the appropriate model (selected based on the patient's race and the sedation method) to identify the desired propofol dosage.

A mathematical model associating the patient factor K and propofol dosage for a particular race and sedation method could be generated as follows. As shown in FIG. 12, a number of data points 1202 are collected for a single race of patients and for a single sedation method. The data points 1202 represent various K values for different patients plotted against the propofol dosages provided to those patients. These data points 1202 are then processed to derive a trend line 1204, which represents the overall mathematical relationship between at least some of the K values and the propofol dosage.

In some embodiments, the data points 1202 are processed to derive the trend line 1204 as follows. The TTD values associated with the data points 1202 are identified, and the median or average TTD value is determined. The data points 1202 associated with TTD values greater than the median or average TTD value are discarded so as to narrow the data set to those data points associated with faster (more desirable) TTD values. Also, various “outliers” can be excluded, which could include outlier data points having better than the median or average TTD value. The average of the patient factor K values for the remaining data points 1202 is calculated, and the remaining data points 1202 are divided into groups. The data points 1202 can be divided into groups based on the average K value and increments of the K value's standard deviation. For instance, the groups can include the data points 1202 for the following ranges, where a denotes the standard deviation of the K value's average:
Group 1: Data points below (Average−1.5σ) patient factor values
Group 2: Data points between (Average−1.5σ) and (Average−1.0σ) patient factor values
Group 3: Data points between (Average−1.0σ) and (Average−0.5σ) patient factor values
Group 4: Data points between (Average−0.5σ) and (Average) patient factor values
Group 5: Data points between (Average) and (Average+0.5σ) patient factor values
Group 6: Data points between (Average+0.5σ) and (Average+1.0σ) patient factor values
Group 7: Data points between (Average+1.0σ) and (Average+1.5σ) patient factor values
Group 8: Data points between (Average+1.5σ) and (Average+2.0σ) patient factor values
Group 9: Data points between (Average+2.0σ) and (Average+2.5σ) patient factor values
Group 10: Data points above (Average+2.5σ) patient factor values
   The average propofol dosage for each group can be calculated and plotted against that group, such as against a midpoint of that group.

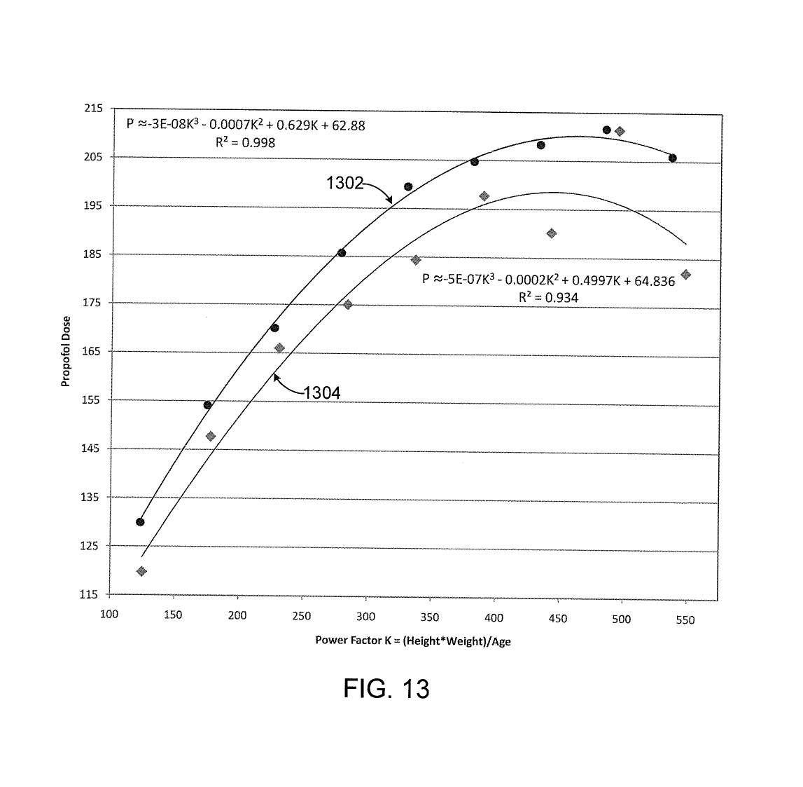

A curve fitting technique (such as standard regression analysis) can be used to fit a linear or non-linear curve to the plotted values. The resulting curve represents the optimal average dose of propofol for the given patient race and sedation technique. The mathematical expression of the resulting curve can therefore be used as the model for the given patient race and sedation technique. An example of this is shown in FIG. 13, where a line 1302 represents a curve fit to all data points 1202 and a line 1304 represents a curve fit to an optimized set of data points 1202 as described above.

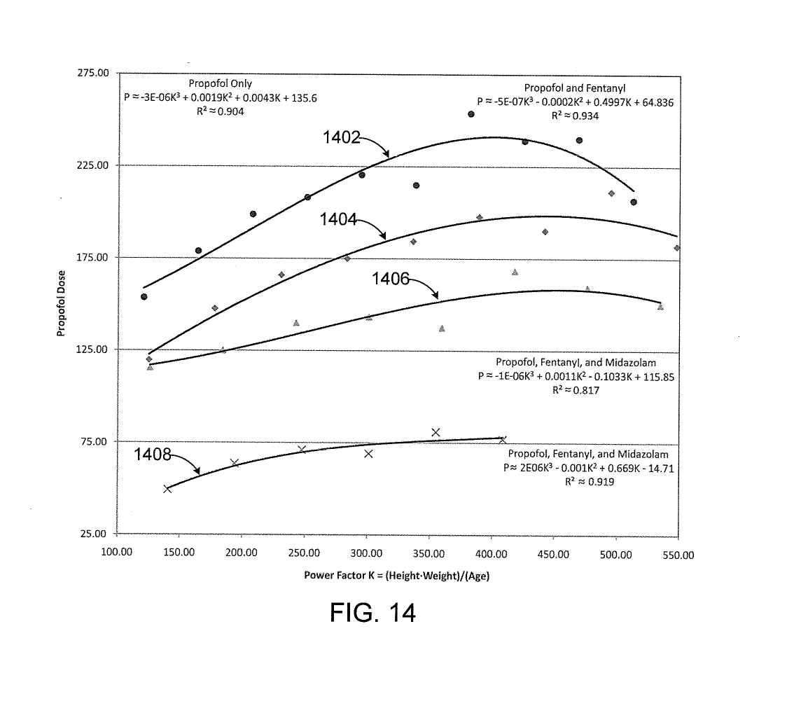

This process can be repeated for each sedation technique using data associated with the same patient race to generate a group of models for that patient race. An example of this is shown in FIG. 14, where lines 1402-1408 identify the mathematical models of optimal propofol dosages for different sedation techniques involving patients of a single race. In particular, line 1402 denotes the mathematical model of optimal propofol dosages for the propofol-only sedation technique. Line 1404 denotes the mathematical model of optimal propofol dosages for the fentanyl-propofol sedation technique. Line 1406 denotes the mathematical model of optimal propofol dosages for the fentanyl-midazolam-propofol sedation technique (with a lower dose of midazolam). Line 1408 denotes the mathematical model of optimal propofol dosages for the fentanyl-midazolam-propofol sedation technique (with a higher dose of midazolam). The same process could be repeated using data associated with different patient races to construct additional sets of models.

The end result of this process is a collection of models that can mathematically represent the optimal dosage of propofol for different patient races and sedation techniques. Information about a particular patient and sedation technique can be used to select the appropriate model and identify the optimal dosage of propofol for that type of patient. Refinements can then be made if necessary.

Note that the models generated here depend upon the collected data points and the mathematical operations used to process the data points. Changes to the data points, the curve-fitting technique, or other aspects of this process can lead to the generation of mathematical expressions for the models that differ from the expressions shown in the figures. As a particular example, additional data points can be collected from medical personnel using the models or from other sources and used to refine the models. Moreover, the number of groups of data points can vary, and some groups could be dropped, such as to eliminate various outlier data points (even data points with acceptable TTD values).

Also note that, as described above, models can be generated for use during different stages of a surgical procedure. For example, models can be constructed to identify the optimal dosages of propofol for the initial stage(s) of a medical procedure, for the final stage(s) of the medical procedure, and/or for any intervening stage(s) of the medical procedure.

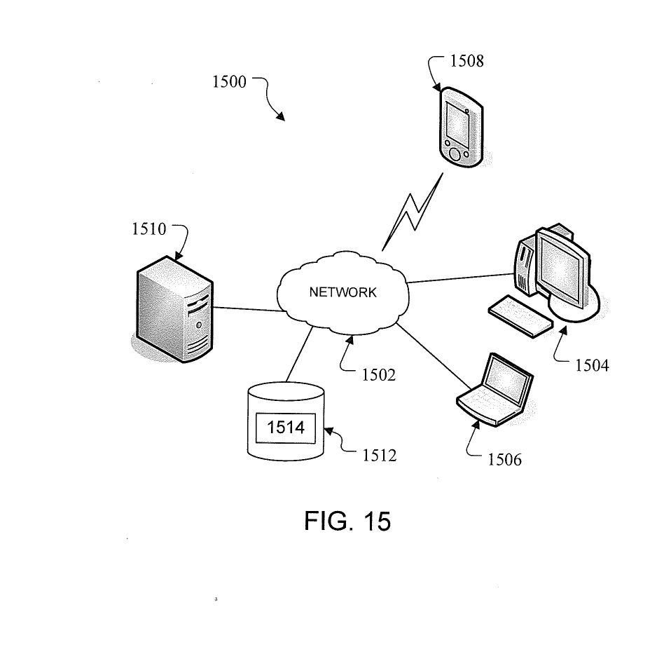

FIG. 15 illustrates an example system 1500 for modeling and predicting the effects of sedatives, such as propofol, on patients according to this disclosure. As shown in FIG. 15, the system 1500 includes a network 1502, which facilitates communication between various components in the system 1500. For example, the network 1502 may communicate Internet Protocol (IP) packets, frame relay frames, Asynchronous Transfer Mode (ATM) cells, or other information between network addresses. The network 1502 may include one or more local area networks (LANs), metropolitan area networks (MANS), wide area networks (WANs), all or a portion of a global network such as the Internet, or any other communication system or systems at one or more locations.

The system 1500 also includes various user devices 1504-1508. The user devices 1504-1508 represent computing or communication devices used by medical personnel to send and receive data. Each user device 1504-1508 includes any suitable device that supports interaction with a user. Each user device 1504-1508 can communicate using any suitable wired or wireless communication mechanism. In this example, the user devices 1504-1508 include a desktop computer, a laptop computer, and a smartphone or personal digital assistant. However, any other or additional type(s) of user device(s) could be used in the system 1500, such as a tablet computer.

One or more servers 1510 and one or more databases 1512 support the use of one or more models 1514. The models 1514 represent models identifying the optimal dosages of propofol for different types of patients. The servers 1510 could allow medical personnel to use the devices 1504-1508 to interact with the servers 1510, provide patient data to the servers 1510, and receive optimal propofol dosages from the servers 1510. The servers 1510 could also support model building functions that receive data and generate or refine the models 1514. As a particular example, medical personnel using the devices 1504-1508 could provide data points to the servers 1510 for use in generating new models 1514 or updating existing models 1514. This can allow refinement of the optimal propofol dosages as more data is collected over time.

Each server 1510 includes any suitable computing device or other device for operating a model. For instance, a web server could be used to interact with web browsers on the user devices 1504-1508 over the network 1502, and an application server could be used to execute applications such as for using models to identify propofol dosages and for refining the models. Each database 1512 includes any suitable data storage and retrieval device(s).

Each computing device in FIG. 15 (such as each user device 1504-1508 and server 1510) includes any suitable structure for performing the described functions. Each computing device could, for example, include one or more processing units, one or more memory units storing data and instructions used, generated, or collected by the processing unit(s), and one or more interfaces for communicating over the network 1502 or other communication link(s).

In particular embodiments, at least some of the user devices 1505-1508 execute an “app” that facilitates interaction with the server 1510. For example, the app could collect a specific patient's data and an identification of a particular sedation technique from a user, transmit the data to the server 1510, and receive an optimal propofol dosage from the server 1510 for display to the user. If supported, the app could also allow a user to provide to the server 1510 information that can help to update a model, such as a particular patient's propofol dosage and time to discharge. Combined with other data about the patient, this information can be used as additional data points 1202 to build new models 1514 or refine existing models 1514.

Note that while shown as supporting a distributed architecture here, the functionality of the server 1510 could be incorporated into the user devices 1504-1508. For example, one or more applications and one or more models could be stored on a user device 1504-1508, where the applications interact with the models in order to identify optimal propofol dosages and possibly to create or refine the models. In general, there are numerous configurations in which one or more computers can be used to support the identification of optimal propofol dosages and the generation or refinement of models. FIG. 15 illustrates one such configuration, but numerous other configurations are also possible.

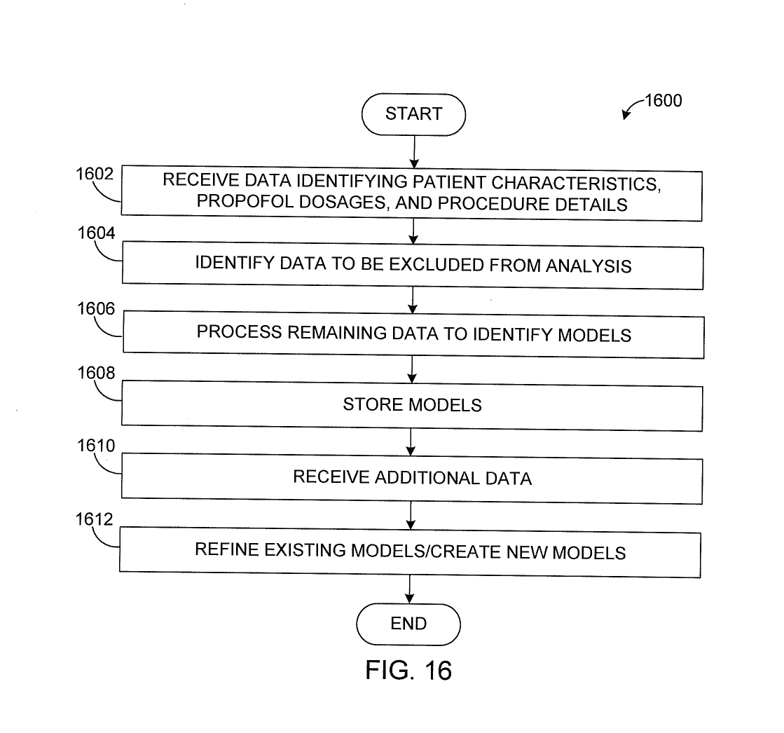

FIG. 16 illustrates an example method 1600 for modeling the effects of sedatives, such as propofol, on patients according to this disclosure. As shown in FIG. 1600, data identifying various patient characteristics, propofol dosages, and procedure details are received at step 1602. This could include, for example, the server 1510 receiving data identifying various patients' heights, weights, ages, and races. This could also include the server 1510 receiving data identifying those patients' propofol dosages, the sedation techniques used on those patients, and those patients' total times to discharge.

Data to be excluded from analysis is identified at step 1604. This could include, for example, the server 1510 excluding data associated with patients who had total times to discharge greater than the average or median total time to discharge. Any other or additional technique could be used to identify data to be excluded.

The remaining data is processed to identify models for propofol dosages at step 1606. This could include, for example, dividing the remaining data points based on patient race and sedation technique. For each unique patient race-sedation technique combination, this could also include identifying average propofol dosages for different K value subsets as described above, plotting the average propofol dosages against the K values, and performing a curve fitting algorithm. The resulting models are stored at step 1608.

Additional data could be received at step 1610 and used to refine the existing models and/or create new models at step 1612. This could include, for example, medical personnel providing additional patient data and propofol dosages to the server 1510. The process shown in steps 1604-1608 could then be repeated using the additional data.

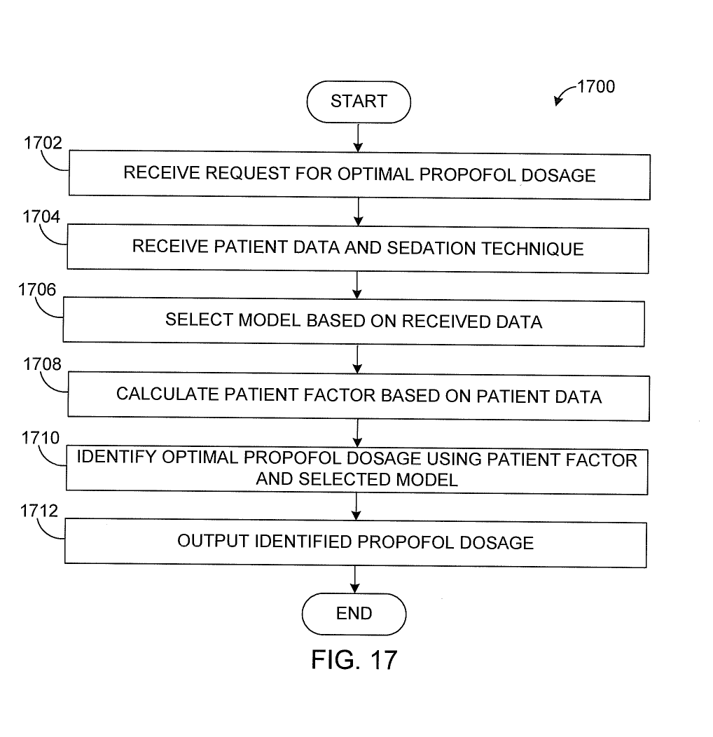

FIG. 17 illustrates an example method 1700 for predicting the effects of sedatives, such as propofol, on patients according to this disclosure. As shown in FIG. 17, a request to identify an optimal propofol dosage is received at step 1702. Also, patient data and information identifying a sedation technique are received at step 1704. This could include, for example, the server 1510 receiving a request from a user device 1504-1508. The request could identify the patient data and sedation technique, or the patient data and/or sedation technique could be sent separately. The patient data could include the patient's height, weight, age, and race or information based on one or more of these values (such as a BMI value).

A model is selected based on the received data at step 1706. This could include, for example, the server 1510 selecting a model 1514 based on the patient's race and the sedation technique to be used. A patient factor (K value) is calculated using the patient data at step 1708. This could include, for example, multiplying the patient's height and weight and dividing the resulting product by the patient's age.

An optimal propofol dosage is identified at step 1710. This could include, for example, using the calculated patient factor and the selected model to identify the optimal propofol dosage. The optimal propofol dosage is output at step 1712. This could include, for example, the server 1510 providing the optimal propofol dosage to the user device 1504-1508.

The figures and the above description have shown and described various techniques and devices for modeling and predicting the sedative effects of drugs, such as propofol, on patients. However, various changes and modifications could be made to the described techniques and devices. For example, any suitable mathematical operations can be performed to convert data into mathematical models. Also, this disclosure is not limited to mathematical models that associate K values to propofol dosages. Any suitable index value can be calculated based on patient characteristic(s) and used to access a model. Further, other or additional patient characteristics could be treated as factors affecting propofol dosage. In addition, while various figures illustrating methods show sequences of steps, these steps can be reordered, occur in parallel, or occur any number of times. Finally, the various techniques and devices described here are not limited to modeling propofol dosages (optionally with fentanyl and midazomal). Any other suitable medication(s) could be used in addition to propofol, such as opioids and benzodiazepines. Moreover, dosages for medications other than propofol could be modeled in the same or similar manner as that described above.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving characteristics of a patient to be administered a sedative for a medical procedure;
selecting one of multiple models based on (i) at least one of the characteristics and (ii) a sedation technique to be used;
calculating an index to the selected model using one or more of the characteristics; and
identifying a specified dosage of the sedative using (i) the selected model and (ii) the calculated index.

2. The method of claim 1, wherein:
the characteristics of the patient include a height, a weight, an age, and a race of the patient; and
selecting one of multiple models comprises selecting one of the multiple models based on the patient's race and the sedation technique to be used.

3. The method of claim 2, wherein the multiple models comprise different models associated with different sedation techniques.

4. The method of claim 3, wherein the models associated with the different sedation techniques comprise:
models associated with administration of propofol only;
models associated with administration of fentanyl and propofol;
models associated with administration of fentanyl, midazolam at a lower dosage, and propofol; and
models associated with administration of fentanyl, midazolam at a higher dosage, and propofol.

5. The method of claim 2, wherein calculating the index comprises multiplying the patient's height by the patient's weight and dividing a resulting product by the patient's age.

6. The method of claim 1, further comprising:
generating the models by:
obtaining information comprising sedation dosages and index values associated with multiple patients;
excluding a portion of the information; and
analyzing a remaining portion of the information to identify the models.

7. The method of claim 6, wherein excluding the portion of the information comprises:
identifying an average or median total time to discharge for the multiple patients; and
excluding the sedation dosages and index values associated with patients having total times to discharge greater than the average or median total time to discharge.

8. The method of claim 6, wherein analyzing the remaining portion of the information comprises:
identifying an average index value in the remaining portion of the information;
dividing the sedation dosages in the remaining portion of the information into multiple groups based on the average index value and a standard deviation of the average index value;
for each group, calculating an average sedation dosage;
plotting the average sedation dosages of the groups against the index values; and
fitting a curve to the plotted average sedation dosages.

9. The method of claim 6, further comprising:
receiving additional information comprising additional sedation dosages and index values; and
at least one of: refining at least one of the models and generating at least one new model using the additional information.

10. An apparatus comprising:
at least one memory configured to store multiple models, each model associated with dosages of a sedative for a medical procedure; and
at least one processing device configured to:
receive characteristics of a patient to be administered the sedative;
select one of the models based on (i) at least one of the characteristics and (ii) a sedation technique to be used;
calculate an index to the selected model using one or more of the characteristics; and
identify a specified dosage of the sedative using (i) the selected model and (ii) the calculated index.

11. The apparatus of claim 10, wherein:
the characteristics of the patient include a height, a weight, an age, and a race of the patient; and
the at least one processing device is configured to select one of the multiple models based on the patient's race and the sedation technique to be used.

12. The apparatus of claim 11, wherein the multiple models comprise different models associated with different sedation techniques.

13. The apparatus of claim 12, wherein the models associated with the different sedation techniques comprise:
models associated with administration of propofol only;
models associated with administration of fentanyl and propofol;
models associated with administration of fentanyl, midazolam at a lower dosage, and propofol; and
models associated with administration of fentanyl, midazolam at a higher dosage, and propofol.

14. The apparatus of claim 11, wherein the at least one processing device is configured to calculate the index by multiplying the patient's height by the patient's weight and dividing a resulting product by the patient's age.

15. The apparatus of claim 10, wherein the at least one processing device is further configured to generate the models by:
obtaining information comprising sedation dosages and index values associated with multiple patients;
excluding a portion of the information; and
analyzing a remaining portion of the information to identify the models.

16. The apparatus of claim 15, wherein the at least one processing device is configured to exclude the portion of the information by:
identifying an average or median total time to discharge for the multiple patients; and
excluding the sedation dosages and index values associated with patients having total times to discharge greater than the average or median total time to discharge.

17. The apparatus of claim 15, wherein the at least one processing device is configured to analyze the remaining portion of the information by:
identifying an average index value in the remaining portion of the information;
dividing the sedation dosages in the remaining portion of the information into multiple groups based on the average index value and a standard deviation of the average index value;
for each group, calculating an average sedation dosage;
plotting the average sedation dosages of the groups against the index values; and
fitting a curve to the plotted average sedation dosages.

18. A non-transitory computer readable medium embodying a computer program, the computer program comprising computer readable program code for:
receiving characteristics of a patient to be administered a sedative for a medical procedure;
selecting one of multiple models based on (i) at least one of the characteristics and (ii) a sedation technique to be used;
calculating an index to the selected model using one or more of the characteristics; and
identifying a specified dosage of the sedative using (i) the selected model and (ii) the calculated index.

19. The computer readable medium of claim 18, wherein:
the characteristics of the patient include a height, a weight, an age, and a race of the patient;
the computer readable program code for selecting one of multiple models comprises computer readable program code for selecting one of the multiple models based on the patient's race and the sedation technique to be used;
the multiple models comprise different models associated with different sedation techniques; and
the computer readable program code for calculating the index comprises computer readable program code for multiplying the patient's height by the patient's weight and dividing a resulting product by the patient's age.

20. The computer readable medium of claim 18, wherein the computer program further comprises computer readable program code for generating the models by:
obtaining information comprising sedation dosages and index values associated with multiple patients;
excluding a portion of the information; and
analyzing a remaining portion of the information to identify the models.
